(19) United States
(12) Patent Application Publication
(10) Pub. No.: US 2025/0124317 A1
(43) Pub. Date: Apr. 17, 2025

(54) Ranking algorithm for retrieval of relationships from texts

(71) Applicant: Jinfeng Zhang, Tallahassee, FL (US)

(72) Inventor: Jinfeng Zhang, Tallahassee, FL (US)

(21) Appl. No.: 18/904,068

(22) Filed: Oct. 1, 2024

Related U.S. Application Data
(60) Provisional application No. 63/589,669, filed on Oct. 12, 2023.

(51) Int. Cl. G06N 7/01

(52) U.S. Cl. CPC G06N 7/01

(57) ABSTRACT

This invention provides a method for probabilistically inferring indirect causal relations between entities, comprising extracting direct relations between entities from textual data using a machine learning algorithm; calibrating the predicted probabilities for each instance of an entity pair if necessary; calculating probabilities for each of said direct relations; and determining the probability of indirect relations between entities using said probabilities of direct relations. It also provides a system for probabilistically inferring indirect causal relations, comprising a processor programmed to perform the above method; a storage medium containing textual data with entity relations; and an output interface for presenting said inferred indirect relations.

### CROSS-REFERENCE TO RELATED APPLICATION

This application claims priority to U.S. provisional patent application Ser. No. 63/589,669, filed Oct. 12, 2023, the entire contents of which is incorporated herein by reference.

### FIELD OF THE INVENTION

The inventions described below relates generally to a method for probabilistically inferring indirect causal relations between entities in the application of drug repurposing.

### BACKGROUND OF THE INVENTION

Advances in high-throughput technologies have enabled the generation of vast amounts of research data and results, much of which is published as unstructured text in scientific literature and deposited in various databases. This information explosion poses a major challenge for researchers to identify and develop new ideas using all the available data. Automated knowledge discovery (a.k.a. automated hypothesis generation) can help mitigate this problem by automating the process of data analysis, identifying patterns, and generating new insights and hypotheses. In recent years, knowledge graphs (KGs) have been proposed as a powerful data structure for integrating heterogeneous data and automated knowledge discovery (AKD). To construct KGs from unstructured text, a practical method is to use named entity recognition (NER) to identify key biological entities and use relation extraction (RE) methods to extract their relationships.

Historically, NER and RE have been collectively referred to as information retrieval tasks. Early automated methods mainly fell into two categories: rule-based and machine learning-based. The rule-based approach systematically extracted specific data based on predefined rules while the machine learning-based approach inferred rules from annotated data for broader knowledge extraction tasks. The advent of machine learning led to more sophisticated methods that leveraged semantic information and sentence structure, resulting in significant improvements in information extraction effectiveness. However, a gap remained compared to human proficiency.

The emergence of deep learning models has allowed for more nuanced utilization of information, such as semantic content and grammatical structures. By expanding the use of features and enhancing expressive capabilities, deep models have significantly improved the overall effectiveness of information extraction. Recently, the technique of pretraining has garnered considerable attention, expanding both model complexity and the amount of training data, and achieving remarkable progress in information retrieval tasks. This was evidenced by significant results in the BioCreative VII Challenge in 2021, where the outcomes closely matched human annotator performance. In that challenge, all the top performers finetuned various BERT based models. Subsequently, a highly advanced series of pretrained models, like GPT-4, emerged. These models have been proven to outperform humans in several tasks, marking a notable advancement in the field.

For both NER and RE tasks, deep learning models fine-tuned using the latest pretrained large language models have recently achieved performance levels comparable to human annotations. We have developed a pipeline for constructing knowledge graphs recently and applied it to all PubMed abstracts. We further integrated relation data from 40 public databases. This has resulted in the creation of the largest-scale biomedical KG to date. This KG covers twelve major biological entity types and fifty-three types of relations, offering great potential for developing more effective tools for information retrieval, integration, and knowledge discovery. To further enhance it for causal inference, we annotated the directions of relations in the LitCoin dataset and built a deep learning model for predicting the direction of relations.

One challenge associated with large-scale information extraction is that although at instance level, a model can achieve a very balanced precision and recall, the false positive rate can be dramatically inflated at entity pair level. A pair of entities may co-occur in multiple PubMed abstracts. Each co-occurrence is called an instance of this entity pair. If any one of the co-occurrences is predicted as a certain relation, we will assign this relation to this entity pair even if all the other co-occurrences are predicted as no relations. For some common entities, even if there are no relations among them, they can co-occur in many different abstracts. Each occurrence will need to be predicted by the model and by chance some occurrences may be wrongly predicted, which will result in wrong relations between the entities. To address this challenge, we designed an interpretable, probabilistic semantic reasoning (PSR) approach for inferring indirect causal relations using the KG. PSR uses a probabilistic approach to rank all the extracted relations with sound mathematical foundation. However, it needs reasonably estimated probabilities for each extracted instance. Unfortunately, it is well-known that deep learning models are notorious for being overly confident about their predictions and the output probabilities are highly screwed towards two ends of the spectrum. To cope with that we had to calibrate the probabilities from the deep learning models. With calibrated probabilities and PSR, our procedure can rank the extracted relations highly accurately. The preliminary results for drug repurposing (DR) have been very promising: PSR can identify large numbers of drug candidates for disease targets (and vice versa for drug targets). For each candidate, it can identify many genes connecting the drug and disease, providing comprehensive supporting evidence, which has not been seen in any of the drug repurposing studies previously.

Below we provide a brief review of prior drug repurposing approaches and delve into the advantages of utilizing KG for drug repurposing. Drug repurposing methods strive to identify probable therapeutic relationships between candidate drug-disease pairs. These methods either infer such relationships directly, or indirectly via an intermediary, typically the drug target of the diseases. Accordingly, we can categorize them into two types: direct inference methods and target-based inference methods. Direct inference methods encompass signature matching, clinical data mining, and machine learning/deep learning-based techniques. Target-based inference methods can be subdivided into three categories: (1) inference of drug-target relationships given target-disease relationships, utilizing techniques like ligand-based and structure-based drug design; (2) inference of target-disease relationships given drug-target relationships, utilizing methods like pathway/network methods and genome-wide association studies; and (3) direct drug-disease relationship inference based on both known drug-target and target-disease relationships, using knowledge graph (KG)-based methods.

### SUMMARY OF THE INVENTION

This invention provides a method for probabilistically inferring indirect causal relations between entities using KG-based methods. These methods, relying on known drug-target and target-disease relationships from literature, offer a higher probability of identifying true drug-disease relations and reduce uncertainty. Moreover, KG-based methods provide higher interpretability, especially compared to machine learning/deep learning methods, and can generate extensive supporting evidence to further enhance interpretability. Additionally, KG-based methods can infer adverse events using the same framework, facilitating simultaneous modeling of therapeutic and adverse effects. Particularly, a method for probabilistically inferring indirect causal relations between entities, comprising extracting direct relations between entities from textual data using a machine learning algorithm; calibrating the predicted probabilities for each instance of an entity pair if necessary; calculating probabilities for each of said direct relations; and determining the probability of indirect relations between entities using said probabilities of direct relations.

In one embodiment, this invention provides a method for probabilistically inferring indirect causal relations between entities, comprising: extracting direct relations between entities from textual data using a machine learning algorithm; calibrating the predicted probabilities for each instance of an entity pair if necessary; calculating probabilities for each of said direct relations; and determining the probability of indirect relations between entities using said probabilities of direct relations.

In another embodiment, this invention provides a method for probabilistically inferring indirect causal relations between entities, comprising: extracting direct relations between entities from textual data using a machine learning algorithm; calibrating the predicted probabilities for each instance of an entity pair if necessary; calculating probabilities for each of said direct relations; and determining the probability of indirect relations between entities using said probabilities of direct relations; wherein said entities are represented as A, B, and C, with the indirect relation inferred from A to C via an intermediate entity B or a set of intermediate entities.

In another embodiment, this invention provides a method for probabilistically inferring indirect causal relations between entities, comprising: extracting direct relations between entities from textual data using a machine learning algorithm; calibrating the predicted probabilities for each instance of an entity pair if necessary; calculating probabilities for each of said direct relations; and determining the probability of indirect relations between entities using said probabilities of direct relations, wherein said extracting comprises parsing multiple instances of direct relations between said entities from textual data sources to generate predicted probabilities for each instance; calibrating the predicted probabilities to obtain calibrated probabilities which are estimates of the true precisions for those predicted to be true; wherein the calibration employs at least one method selected from the group consisting of Platt Scaling, Isotonic Regression, Histogram Binning (Quantile Binning), Beta Calibration, Temperature Scaling, Bayesian Binning into Quantiles (BBQ), Dirichlet Calibration, Ensemble Methods, and variations thereof. Yet in a further embodiment, when isotonic regression is used, the method comprises dividing said probabilities into multiple intervals and estimating the precision for each interval.

In another embodiment, this invention provides a method for probabilistically inferring indirect causal relations between entities, comprising: extracting direct relations between entities from textual data using a machine learning algorithm; calibrating the predicted probabilities for each instance of an entity pair if necessary; calculating probabilities for each of said direct relations; and determining the probability of indirect relations between entities using said probabilities of direct relations; wherein the method further comprising calculating an overall probability of a direct relation between two entities using the formula:

P_{A,B}=1−Πⱼ₌₁ⁿ(1−p_{A,B}^{j}), wherein p_{A,B}^{j} is the probability of the j-th occurrence of

said direct relation being true.

In another embodiment, this invention provides a method for probabilistically inferring indirect causal relations between entities, comprising: extracting direct relations between entities from textual data using a machine learning algorithm; calibrating the predicted probabilities for each instance of an entity pair if necessary; calculating probabilities for each of said direct relations; and determining the probability of indirect relations between entities using said probabilities of direct relations; wherein said entities are represented as A, B, and C, with the indirect relation inferred from A to C via an intermediate entity B or a set of intermediate entities; the indirect relation between entities A and C through multiple intermediate entities, denoted Bᵢ, is calculated as:

$${P}_{A , {B}_{i} , C} = {P}_{A , {B}_{i}} \times {P}_{{B}_{i} , C}$$

In a further embodiment, this invention provides a method for probabilistically inferring indirect causal relations between entities, comprising: extracting direct relations between entities from textual data using a machine learning algorithm; calibrating the predicted probabilities for each instance of an entity pair if necessary; calculating probabilities for each of said direct relations; and determining the probability of indirect relations between entities using said probabilities of direct relations; wherein said entities are represented as A, B, and C, with the indirect relation inferred from A to C via an intermediate entity B or a set of intermediate entities; wherein the probability of an indirect relation between entities A and C through m intermediate entities is:

$${P}_{A , \cdot , C} = 1 - {\prod }_{i = 1}^{m} ( 1 - {P}_{A , {B}_{i} , C} )$$

In another embodiment, this invention provides a method for probabilistically inferring indirect causal relations between entities, comprising: extracting direct relations between entities from textual data using a machine learning algorithm; calibrating the predicted probabilities for each instance of an entity pair if necessary; calculating probabilities for each of said direct relations; and determining the probability of indirect relations between entities using said probabilities of direct relations; wherein said indirect relation probability is calculated as:

$${P}_{A , \cdot , C} = 1 - {\prod }_{i = 1}^{m} [ 1 - [ 1 - {\prod }_{j = 1}^{n} ( 1 - {p}_{A , {B}_{i}}^{j} ) ] \times [ 1 - {\prod }_{k = 1}^{l} ( 1 - {p}_{{B}_{i} , C}^{k} ) ] ]$$

In another embodiment, this invention provides a method for probabilistically inferring indirect causal relations between entities, comprising: extracting direct relations between entities from textual data using a machine learning algorithm; calibrating the predicted probabilities for each instance of an entity pair if necessary; calculating probabilities for each of said direct relations; and determining the probability of indirect relations between entities using said probabilities of direct relations; wherein the type of correlation between two entities is determined by multiplying correlation values for intermediate entities, where 1 represents positive correlation, −1 represents negative correlation, and 0 represents unknown correlation.

In another embodiment, this invention provides a method for probabilistically inferring indirect causal relations between entities, comprising: extracting direct relations between entities from textual data using a machine learning algorithm; calibrating the predicted probabilities for each instance of an entity pair if necessary; calculating probabilities for each of said direct relations; and determining the probability of indirect relations between entities using said probabilities of direct relations, wherein said extracting comprises parsing multiple instances of direct relations between said entities from textual data sources to generate predicted probabilities for each instance; calibrating the predicted probabilities to obtain calibrated probabilities which are estimates of the true precisions for those predicted to be true. The calibration can adopt different methods and one such method is isotonic regression by dividing said probabilities into multiple intervals and estimating the precision for each interval. and wherein said intervals range from 5 to 10 based on the availability of data.

In yet another embodiment, this invention discloses a system for probabilistically inferring indirect causal relations, comprising: a processor programmed to perform the method for probabilistically inferring indirect causal relations between entities; a storage medium containing textual data with entity relations; and an output interface for presenting said inferred indirect relations. In another embodiment, said system further comprises an input interface for receiving additional textual data for processing.

In another embodiment, this invention further provides a non-transitory computer-readable medium storing instructions which, when executed by a processor, cause the processor to perform the method for probabilistically inferring indirect causal relations between entities.

### BRIEF DESCRIPTION OF DRAWINGS

FIG. 1 provides the overview of our drug repurposing strategy and validation approach.

FIG. 2 provides the drug repurposing results for COVID-19

FIG. 3 illustrates drug repurposing using indirect relationship searches.

FIG. 4 illustrates drug repurposing for Chordoma.

### DETAILED DESCRIPTION OF DRAWINGS

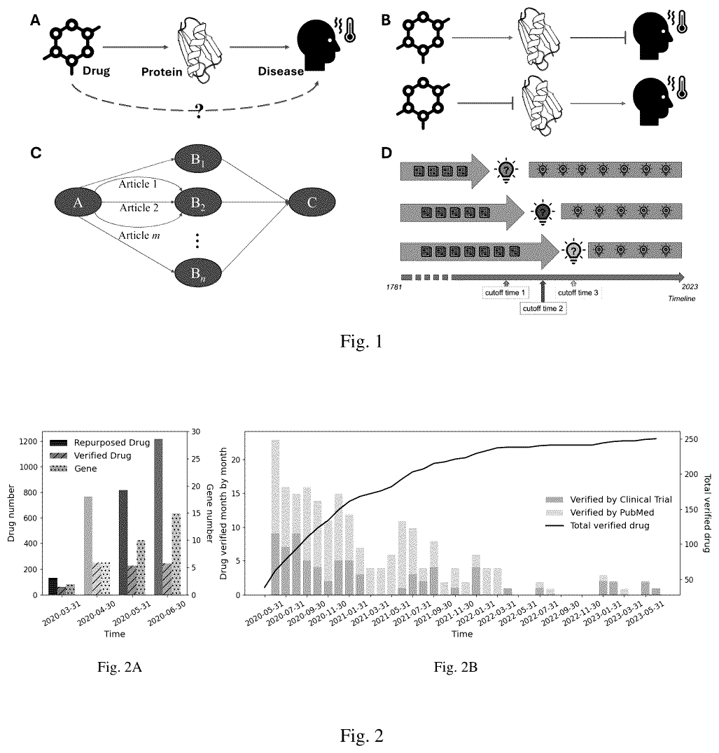

FIG. 1 illustrates the overview of our drug repurposing strategy and validation approach. A. Our method infers drug-disease therapeutic relations through identifying an intermediate entity, the drug target of the disease, with causal relations from the drug to a drug target, and from the drug target to the disease. B. Two scenarios correspond to a drug-disease therapeutic relation: drug activates a target, and the target represses the disease, or drug inhibits the target, and the target promotes the disease. C. To infer an indirect relation from A (i.e. a drug) to C (i.e. a disease), there can be many intermediate potential targets between them. For each relation formed by two entities, there could be many scientific articles mentioning it. PSR algorithm aggregates all the information to make the inference. D. To validate a drug repurposing study, we use a time-sensitive approach. We select many cutoff time points and use the knowledge published before the cutoff time to generate predictions and use the knowledge published after the cutoff time to validate our predictions.

FIG. 2 illustrates drug repurposing for COVID-19. FIG. 2A illustrates Drug repurposing results for four consecutive months from March to June 2020. The three bars show the numbers of repurposed drugs, numbers of verified drugs and the numbers of genes that were reported as drug targets for COVID-19 during the corresponding time periods. FIG. 2B illustrates he number of repurposed drugs that were verified each month from May 2020 to May 2023 for the drugs repurposed in April 2020 (The orange bar on the left figure). About one third of the repurposed drugs were verified later in PubMed abstracts or clinical trials.

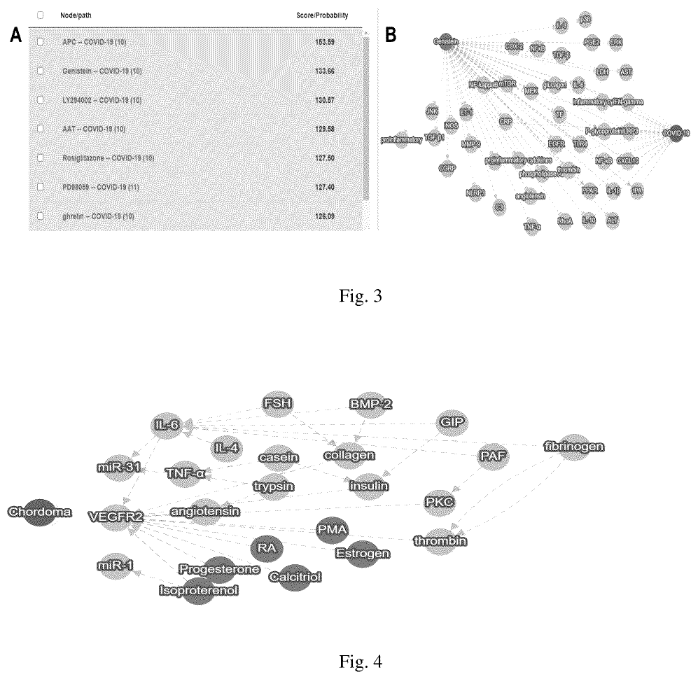

FIG. 3. Illustrates drug repurposing using indirect relationship searches. A. The result from searching COVID-19 as disease for entity 1, drug as the type of entity 2, negative correlation as the relationship type, and entity 2->entity 1 as direction. By default, only a small number of top genes will be shown for each candidate drug/disease. For all the seven candidates, we have found hypothesis articles suggesting that they can be used as potential treatment for COVID-1971-77. B. Users can find more genes linking the drug and disease by performing another indirect search by specifying the drug name, for example, Genistein, in this case, which gives 81 genes connecting Genistein and COVID-19. The figure showed those with probability greater than 0.9.

FIG. 4 illustrates drug repurposing for Chordoma. Chordoma has 13 drug targets. Three drug targets (miR-31, VEGFR2, and miR-1) lead to repurposed drugs with five protein drugs (FSH, BMP-2, GIP, fibrinogen, and PAF) and six small molecule drugs (Isoproterenol, RA, Progesterone, Calcitriol, PMA, and Estrogen). On the web tool, clicking the edges will open a popup window that shows the sentences describing the corresponding relations.

### DETAILED DESCRIPTION OF THE INVENTION

It is to be understood that the invention of the present disclosure is not limited to the specific devices, conditions, or parameters of the representative embodiments described and/or shown herein, and that the terminology used herein is for the purpose of describing particular embodiments by way of example only. Thus, the terminology is intended to be broadly construed and is not intended to be unnecessarily limiting of the claimed invention. For example, as used in the specification including the appended claims, the singular forms “a,” “an,” and “the include the plural, the term “or” means “and/or,” and reference to a particular numerical value includes at least that particular value, unless the context clearly dictates otherwise. In addition, any methods described herein are not intended to be limited to the sequence of steps described but can be carried out in other sequences, unless expressly stated otherwise herein.

### Developing State-of-the-Art NER and RE Pipelines for KG Construction

We have developed several methods for biological relation extraction and applied them to AKD, previously. Due to limit in space, we will only describe the work we did in the LitCoin NLP Challenge. LitCoin NLP Challenge dataset contains 500 PubMed abstracts with six entity types and eight relation types manually annotated at abstract level.

When developing the pipeline for LitCoin Challenge, we tested a large set of pretrained language models including BERT, BioBERT, PubMedBERT abstract only, PubMedBERT fulltext, sentence BERT, ROBERTa, T5, BlueBERT, SciBERT and ClinicalBERT. We tested many ideas such as different loss functions, data augmentations, different settings of label smoothing, different ways of ensemble learning, etc. Our final pipelines contain the following components: (1) Improved in-house script for data processing including sentence split, tokenization, and entity tagging; (2) ROBERTa large and PubMedBERT models as baseline models for NER task; (3) Ensemble modeling strategy that combines models trained with different parameter settings, different random seeds and at different epochs for both NER and RE; (4) Label smoothing for both NER and RE; (5) Using Ab3P for handling abbreviations for NER; (6) Checking NER consistency within the same document including the full-text part of the articles; (7) Additional manual annotation for relations at sentence level. The relations in LitCoin annotations were given at document level. For all the true relations in the training data, we annotated them at sentence level, if possible. This did not give a very big boost in performance as we expected. The performance only increased by 2-3%. This is likely because the multi-sentence model used inputs that contain more information than single sentences; (8) Modified classification rule tailored for LitCoin scoring method. LitCoin used Jaccard score as the performance measure and for RE used a score that combines performances from three subtasks: binary relation extraction, relation type prediction, and novelty prediction. Partial points are given if positive correlations are predicted as negative correlations and vice versa. We designed a specific classification rule to accommodate this; and (9) Training a multi-sentence model for predicting relations at document level, which gave a very competitive baseline for relation extraction.

Engineering together all the above pieces is a highly non-trivial task. For NER we ranked 2nd with a score of 0.9177. The first and third ranked teams had scores of 0.9309 and 0.9068, respectively. For RE, we ranked 1st with a score of 0.6332 (modified Jaccard score). The second and third ranked teams had scores of 0.5941 and 0.5681, respectively. NER counts for 30% of the total score and RE counts for 70% of the total score. Overall, our method ranked the first for LitCoin NLP challenge.

Entity normalization. In LitCoin challenge, entity IDs were given, and entity normalization (EN, mapping all the synonyms of an entity to a unique ID) was not needed. To construct a general KG for all PubMed abstracts, we need to map all the tagged entities to unique IDs. In BioCreative Challenge VII, our method ranked second for chemical term normalization and ranked first overall for chemical NER, normalization, and indexing. We applied the same methods with some improvement to the NER results in this study. With NER, EN, and RE, we were able to construct a large-scale KG and deploy it on the BioKDE platform.

Manual verification of the large-scale prediction. We randomly selected 50 abstracts and manually read them to verify the predictions. The accuracy is 95.2% and F1-score is 75.9%, which is on par with human expert annotation level. This is better than that on LitCoin dataset. The reason is that LitCoin dataset was not a random sample of PubMed abstracts. It contains substantially more mutation related relations and much fewer chemical-chemical relations, which might have made it more difficult.

Integrating Relations from Public Databases

To integrate the relations in the public databases, we downloaded the relations from two databases that have integrated data from a large number of databases recently, Hetionet⁶⁵ and primeKG, where Hetionet has integrated data from 29 databases and primeKG has integrated data from 20 databases. The total number of unique databases from both sources is 39. In addition, we extracted drug-target relations from Therapeutic Target Database (TTD). In total, we integrated relation data from 40 public databases. The KG covers twelve common entity types including diseases, chemical compounds, organisms, genes/proteins, mutations, cell lines, anatomy, biological process, cellular component, molecular function, pathway, and pharmacologic class. It covers fifty-three different relation types. Among them the following eight were annotated in the LitCoin dataset: association, positive correlation, negative correlation, bind, cotreatment, comparison, drug interaction, and conversion. Other relation types came from public databases.

Incorporating Relations from Analyzing RNASeq Data

We downloaded more than 300,000 human RNASeq profiles from recount3 database. We performed two types of analysis: differential gene expression analysis (DGEA) and gene regulatory network inference (GRNI). DGEA gave 92,628 differentially expressed genes for 36 different diseases, which correspond to 92,628 disease-gene relations, either positive correlation or negative correlation depending on whether the genes are up or down regulated in the corresponding diseases. GRNI gave 101,392 gene regulatory relations overall. In total, we added close to 200,000 new relations by analyzing this RNASeq dataset.

Table 1 compares the number of relations we extracted from PubMed abstracts and those obtained from the public databases (sum of all 40 databases) for a few relation types. We extracted significantly more relations than those in the public databases.

Table 1. Comparison of number of relations extracted from PubMed abstracts with those from public databases. BioKDE (Biomedical Knowledge Discovery Engine) is our database. * Disease—disease relations are not included because in LitCoin challenge dataset, this type of relation was not annotated. ** Protein-protein interactions obtained using high-throughput experiments were not included since they are known to be very noisy. *** Drug Target-Disease relations are Gene-Disease relations with direction from genes to diseases.

| Relation Type * | # in the public databases | # in BioKDE |
|---|---|---|
| Chemical - Gene | 4,229,590 | 6,684,476 |
| Chemical - Chemical | 1,337,757 | 5,178,511 |
| Gene - Gene | 795,601** | 3,940,172 |
| Chemical - Disease | 275,556 | 5,043,538 |
| Disease - Gene | 119,091 | 7,821,076 |
| Drug Target - Disease | 10,143 | 2,253,229 *** |

### Predicting the Direction of Relations

We annotated the direction information for all the correlation relations (positive and negative correlation) in the LitCoin dataset and trained a deep learning model for predicting the direction of relations. There are totally 4,572 cases. Among them 2,009 cases have direction from the first entity to the second; 1,611 cases have direction from the second entity to the first; and 952 cases have no direction. The model achieved an F1 score of 0.924 in a 5-fold cross-validation tested on the LitCoin dataset. We applied the model to the relations extracted from PubMed abstracts. We define a unique relation by a quartet: (entity ID 1, entity ID 2, relation type, and relation direction), where entity ID 1 and ID 2 are sorted.

### Probabilistic Semantic Reasoning

We designed a probabilistic framework, probabilistic semantic reasoning (PSR), for inferring indirect causal relations. An advantage of this approach as compared to other machine learning based methods, which often run like a black box, is that the inferred relations are highly explainable. Researchers can read all the literature evidence to easily verify the inferences manually. The overall drug repurposing strategy and validation approach are depicted in FIG. 1 with some details provided in the figure legend.

To simplify the discussion, let's assume we want to infer the indirect relation from A to C using direct relations from A to B and relation from B to C. To infer the indirect relation, we first extract the two direct relations. As mentioned earlier, it is very likely that relation A to B and relation B to C will occur many times in different PubMed abstracts. We calculate the overall probability of whether two entities have a particular relation using the formula, P_{A,B}=1−Πⱼ₌₁ⁿ(1−p_{A,B}^{j}) (Equation 1). In equation 1, P_{A,B} is the overall probability of A-B entity pair having a particular relation, p_{A,B}^{j} is the probability of being true for the j-th occurrence of these two entities in a PubMed abstract, 1−p_{A,B}^{j} is the probability of this occurrence being false, and Πⱼ₌₁ⁿ(1−p_{A,B}^{j}) is the probability that all the occurrences being false (assuming the predictions for these occurrences are independent). The probability of all occurrences being false, when subtracted by 1, gives the probability of at least one of them is true, which is the desired probability. It is also possible that several different relation types will be inferred for a single pair of entities. Many times, only one relation type is the true type and others may be simply wrong predictions. To simplify the inference, we selected the relation type with the highest probability as the true relation type for any pair of entities. In reality, there can be multiple entities linking A to C. We denote one of them as Bᵢ. Then the probability of A to C through Bᵢ can be calculated as P_{A,B}_{ᵢ}_{C}=P_{A,B}_{ᵢ}×P_{B}_{ᵢ}_{C} (Equation 2). Equation 2 is straightforward since for the indirect relation between A to C to be true, both the direct relations need to be true. Again, we assume the predictions for the two direct relations are independent. The probability between A to C through m intermediate nodes can then be calculated as P_{A,·,C}=1−Πᵢ₌₁^{m}(1−P_{A,B}_{ᵢ}_{c}) (Equation 3). In equation 3, we use P_{A,·,C} to denote the probability that the indirect relation between A and C through any intermediate entity and there is m such intermediate entities that link A and C. The argument for this formula is similar to that of equation (1). Putting equations 1-3 together, we get P_{A,·,C}=1−Πᵢ₌₁^{m}[1−[1−[Πⱼ₌₁ⁿ(1−p_{A,B}_{ᵢ}^{j})]×[1−Πₖ₌₁^{l}(1−p_{B}_{ᵢ}_{C}^{k})]](4). In equation 4, there are m entities linking A and C, n instances of A-Bᵢ relations in literature, and l instances of Bᵢ-C relations in literature. It is relatively straightforward to extend this to multiple intermediate nodes between A and C. The above probabilistic framework will allow us to rank all the indirect relations that can be inferred. To infer the relation type (positive correlated or negative correlated) between two entities, which could be linked by multiple intermediate entities, we use 1 to represent positive correlations, −1 to represent negative correlations, and 0 to represent unknown correlation type between any two entities connected by a direct edge and multiply all the correlations together. The resulting value, 1, −1, or 0 will give us the correlation type between the two entities. Basically, if there is at least one unknown correlation type (0) in between the two entities, the overall correlation type is unknown. If there is no 0, and there is even number of negative correlations, then the overall correlation type will be positive correlation, otherwise negative correlation. For A-C entity pair to have a non-zero probability, there must be a path from A to C with all the directions going from A to C, such as A->B->D->C, while A->B<-D->C is not a valid path from A to C.

To use PSR, we need to have meaningful predicted probabilities for all the predictions. However, for deep learning models, it is well-known that they are overly confident, and the predicted probabilities are very screwed towards two ends of the spectrum (very high or very low probabilities). We need to calibrate the predicted probabilities, which is described in the next section.

Calibration of Predicted Probabilities from Deep Learning Models

Single sentence model. We've employed the Isotonic regression model to enhance the relationship probabilities between entity pairs in each publication. To acquire our training data, we ran the LitCoin dataset through our single-sentence relationship prediction pipeline using 5-fold cross-validation to get the predicted probability of each entity pair. This process yielded 3,622 entity pairs with relationships predicted as something other than “NOT”. During our initial preprocessing step, when the true relationship type deviated from “NOT”, we assigned a relation type of 1; otherwise, it was set to 0 for “NOT”. Given that we exclusively worked with pairs predicted with non-“NOT” relationships, all entity pairs had their predicted relationships set to 1. The probability assigned to each entity pair was the sum of non-“NOT” probabilities.

For the training phase of the Isotonic regression model, we randomly selected 2,000 entity pairs and utilized the derived probability as the input feature. The output label was binary: set to 1 if the predicted and actual relationship types matched, and 0 otherwise. We defined the minimum and maximum probability thresholds as 0.5 and 0.95, respectively, and the predictions were adjusted to the value corresponding to the nearest endpoint within this interval.

We subsequently applied this Isotonic model to the test dataset, which consisted of 1,622 entity pairs, to obtain the refined probability. We divided the probability into 5 intervals: (0.5, 0.8116, 0.8346, 0.8531, 0.9398, 0.95). Each interval contained an equal number of data points, except for the last one, which had 2 additional points. We then calculated the precision of the entity pairs in each interval, resulting in precision scores of 0.5494, 0.8024, 0.8272, 0.8333, and 0.9356. When applying this refinement process, the refined probability aligns with the corresponding precision score in the respective interval window.

Multi-sentence model. We implement a calibration process for the relationship probabilities of entity pairs from the multi-sentence model. To obtain our training data, we subjected the LitCoin dataset to our multi-sentence relationship prediction pipeline with a 5-fold cross-validation approach. We selectively retained data points where the paired entities did not exist within the same sentence and where the predicted relationship was non-“NOT.” This filtering yielded a total of 582 entity pairs. Subsequently, we assigned the probability of each entity pair as the sum of probabilities associated with non-“NOT” relation types.

We divided these probabilities into two intervals: (0.2681, 0.9950, 0.9999), with each interval containing 110 and 472 entity pairs, respectively. We calculated the precision of the entities within each interval using the ‘micro’ average method, which computes metrics globally by tallying the total true positives, false negatives, and false positives. The precision scores were determined to be 0.2545 and 0.4407 for the two intervals.

In the process of refining these probabilities, the final probability assigned to entity pairs that do not co-occur in the same sentence is based on the sum of predicted non-“NOT” probabilities and is set to one of these precision values.

### Examples

Application of PSR for drug repurposing for COVID-19

A comprehensive review has summarized many artificial intelligence and network-based methods for drug repurposing for COVID-1970. We conducted a retrospective, real-time drug repurposing study for COVID-1970 spanning from March 2020 to May 2023 (FIG. 2). During this period, we consistently repurposed drugs based on the drug targets reported for COVID-19 between March and June 2020. Our monthly assessments involved scrutinizing whether these repurposed drugs had been subsequently tested in clinical trials documented on ClinicalTrials.gov or had demonstrated therapeutic efficacy in COVID-19 patients through their mention in PubMed abstracts. It is noteworthy that drugs identified in clinical trials may not always translate into effective treatments for COVID-19. Nevertheless, they serve as valuable hypotheses, aligning with the primary objective of our drug repurposing approach. Remarkably, one-third of the repurposed drugs identified during the initial two months were later verified as effective interventions. Importantly, even drugs that did not achieve verification status remain viable hypotheses, warranting further investigation, particularly when existing treatments prove less than optimal.

We can also perform drug repurposing for COVID-19 at the current time. Using the iExplore tool at BioKDE, under Indirect Relationship Search tab, users can search COVID-19 as disease for Entity 1, Drug as the type of Entity 2, Negative Correlation as the Relationship Type, and direction from Entity 2 to Entity 1. One unique feature of PSR is it identifies explicitly the genes that connect COVID-19 and the potential drugs, where either the gene is positively correlated to COVID-19 with direction from gene to COVID-19 (the gene is a causal factor for COVID-19) and the drug is negatively correlated to the gene with direction from drug to the gene, or the gene is negatively correlation to COVID-19 with direction from gene to COVID-19 and the drug is positively correlated to the gene with direction from drug to the gene. In both cases, the inferred relation from the drug and COVID-19 will be negatively correlated (meaning a therapeutic effect) and direction is from drug to COVID-19 (a causal relation from drug to COVID-19). FIG. 3A shows the top seven drug candidates for a drug repurposing search for COVID-19. For all the seven candidates, we have found hypothesis articles proposing that they can be used as potential treatment for COVID-19 (APC, Genistein, LY294002, AAT, Rosiglitazone, PD98059, and ghrelin). The numbers of genes connecting these top seven candidates to COVID-19 range from 45 to 81. By default, only a small number of top genes will be shown for each candidate. Users can find all the genes by performing another indirect search by specifying the drug name. FIG. 3B shows the genes (with probability greater than 0.9) connecting COVID-19 and Genistein, one of the top candidates. Clicking an edge will display all the literature evidence of the corresponding relation so that a manual verification can be conveniently performed. In this search, we have filtered out all the drugs which have been used or tested for treating COVID-19 as reported previously in PubMed literature. Therefore, the result consists of drugs that have not been tested on COVID-19, which can be potential novel discoveries. Being able to select only candidates which have not been used as treatments previously is another unique feature of our approach as it requires a comprehensive knowledge of existing literature, which has not been possible in previous studies.

FIG. 4 displays the drug repurposing results for a rare cancer, Chordoma.

Application of PSR for Drug Repurposing for Some Diseases without Satisfactory Treatments

We applied PSR to 10 well-known diseases without satisfactory treatments (Table 2). Somewhat to our surprise, we repurposed large numbers of drugs for these diseases. We extracted drugs that were mentioned in PubMed literature with therapeutic effect to the disease, which are considered as known drugs. For these known drugs, we can repurpose more than 90% of them. All the repurposed drugs have genes connecting them to the corresponding diseases.

Table 2. Drug repurposing for some common diseases without satisfactory treatments. The known drugs were those drugs that have therapeutic relation with the disease extracted from PubMed. The numbers can be much larger than the FDA approved drugs. Repurposed known drugs are repurposed drugs among the known drugs. The percentage of repurposed drugs among the known drugs is calculated by dividing the number at column 4 by the number at column 3.

| | | | | Percent of |
|---|---|---|---|---|
| | | | | repurposed |
| | Total | | Repurposed | drugs among |
| | Repurposed | Known | Known | the known |
| Disease | Drugs | Drugs | Drugs | drugs |
| Lung Cancer | 1524 | 366 | 335 | 0.915 |
| Prostate Cancer | 1429 | 369 | 343 | 0.930 |
| Alzheimer's | 1300 | 328 | 286 | 0.872 |
| Disease | | | | |
| ALS | 1551 | 123 | 116 | 0.912 |
| Pancreatic Cancer | 1427 | 224 | 219 | 0.978 |
| Colorectal Cancer | 1412 | 340 | 313 | 0.921 |
| Liver Cancer | 1173 | 131 | 125 | 0.954 |
| Cystic Fibrosis | 1091 | 202 | 162 | 0.802 |
| Schizophrenia | 699 | 287 | 235 | 0.819 |
| Parkinson's | 1374 | 390 | 344 | 0.882 |
| Disease | | | | |

### Application of PSR for Drug Repurposing for 10 Common Drugs

We also applied PSR to the top 10 common drugs (Table 3). Again, we can identify a large number of diseases these drugs can be used to treat. For known indications of the drugs, our method has a recall rate of more than 90%. Among the repurposed indications, we also found a relatively large number of diseases without treatment mentioned in PubMed. This indicates that these common drugs can be tested to some of the diseases currently without treatments.

Table 3. Drug repurposing for 10 common drugs. Known indications are those diseases with a therapeutical relation with the corresponding drug extracted from PubMed abstracts. They can be much larger than FDA approved indications. The Percent column is calculated by dividing column 3 by column 2. Repurposed indications with no treatments are those indications in column 5, which have no drug-disease therapeutic relations in PubMed abstracts.

| | | Repurposed | | Total | Repurposed |
|---|---|---|---|---|---|
| | Known | Known | | Repurposed | indication with |
| Drug | Indications | Indications | Percent | Indications | no treatments |
| Metoprolol | 212 | 190 | 0.896 | 3559 | 836 |
| Albuterol | 198 | 164 | 0.828 | 2943 | 563 |
| Acetaminophen | 440 | 323 | 0.734 | 3986 | 989 |
| Levothyroxine | 503 | 435 | 0.865 | 4901 | 1308 |
| Metformin | 999 | 911 | 0.912 | 8177 | 3102 |
| Amlodipine | 230 | 212 | 0.922 | 3967 | 989 |
| Omeprazole | 325 | 227 | 0.698 | 3615 | 796 |
| Lisinopril | 137 | 125 | 0.912 | 2675 | 572 |
| Simvastatin | 646 | 605 | 0.937 | 7165 | 2616 |
| Atorvastatin | 578 | 538 | 0.931 | 6943 | 2484 |

The invention claimed is:

1. A method for probabilistically inferring indirect causal relations between entities, comprising:
extracting direct relations between entities from textual data using a machine learning algorithm;
calibrating the predicted probabilities for each instance of an entity pair if necessary;
calculating probabilities for each of said direct relations; and
determining the probability of indirect relations between entities using said probabilities of direct relations.

2. The method of claim 1, wherein said entities are represented as A, B, and C, with the indirect relation inferred from A to C via an intermediate entity B or a set of intermediate entities.

3. The method of claim 1, wherein said extracting comprises parsing multiple instances of direct relations between said entities from textual data sources to generate predicted probabilities for each instance; calibrating the predicted probabilities to obtain calibrated probabilities which are estimates of the true precisions for those predicted to be true; wherein the calibration employs at least one method selected from the group consisting of Platt Scaling, Isotonic Regression, Histogram Binning (Quantile Binning), Beta Calibration, Temperature Scaling, Bayesian Binning into Quantiles (BBQ), Dirichlet Calibration, Ensemble Methods, and variations thereof.

4. The method of claim 3, wherein when isotonic regression is used, the method comprises dividing said probabilities into multiple intervals and estimating the precision for each interval.

5. The method of claim 1, further comprising:
calculating an overall probability of a direct relation between two entities using the formula:
P_{A,B}=1−Πⱼ₌₁ⁿ(1−p_{A,B}^{j}), wherein p_{A,B}^{j} is the probability of the j-th occurrence of said direct relation being true.

6. The method of claim 2, wherein the indirect relation between entities A and C through multiple intermediate entities, denoted Bᵢ, is calculated as:
$${P}_{A , {B}_{i} , C} = {P}_{A , {B}_{i}} \times {P}_{{B}_{i} , C}$$

7. The method of claim 2, wherein the probability of an indirect relation between entities A and C through m intermediate entities is:
$${P}_{A , \cdot , C} = 1 - {\prod }_{i = 1}^{m} ( 1 - {P}_{A , {B}_{i} , C} )$$

8. The method of claim 1, wherein said indirect relation probability is calculated as:
$${P}_{A , \cdot , C} = 1 - {\prod }_{i = 1}^{m} [ 1 - [ 1 - {\prod }_{j = 1}^{n} ( 1 - {p}_{A , {B}_{i}}^{j} ) ] \times [ 1 - {\prod }_{k = 1}^{l} ( 1 - {p}_{{B}_{i} , C}^{k} ) ] ]$$

9. The method of claim 1, wherein the type of correlation between two entities is determined by multiplying correlation values for intermediate entities, where 1 represents positive correlation, −1 represents negative correlation, and 0 represents unknown correlation.

10. The method of claim 4, wherein said intervals range from 5 to 10 based on the availability of data.

11. A system for probabilistically inferring indirect causal relations, comprising:
a processor programmed to perform the method of claim 1;
a storage medium containing textual data with entity relations; and
an output interface for presenting said inferred indirect relations.

12. The system of claim 11, wherein said system further comprises an input interface for receiving additional textual data for processing.

13. A non-transitory computer-readable medium storing instructions which, when executed by a processor, cause the processor to perform the method of claim 1.
